(19) United States
(12) Patent Application Publication
(10) Pub. No.: US 2025/0245484 A1
(43) Pub. Date: Jul. 31, 2025

(54) BATCH SELECTION FOR TRAINING MACHINE-LEARNED LARGE LANGUAGE MODELS

(71) Applicant: Databricks, Inc., San Francisco, CA (US)

(72) Inventors: Zachary Anker, Boston, MA (US); Mansheej Paul, New York, NY (US)

(21) Appl. No.: 18/425,893

(22) Filed: Jan. 29, 2024

(51) Int. Cl. G06N 3/0455; G06N 3/084

(52) U.S. Cl. CPC G06N 3/0455; G06N 3/084

(57) ABSTRACT

A system performs a batch selection process on a small model and uses the results of batch selection to train a large language model (LLM). The system receives training examples and splits the training examples into a holdout set and an evaluation set. Each training example corresponds to a label. The system uses trains a small model using the training examples of the holdout set. The system evaluates the small model on the training examples of the evaluation set, generating a prediction for each training example and computing a loss between the prediction and the training example's label. The system generates an LLM training set by selecting a set of training examples from the evaluation set with the highest loss. The system trains the LLM using the LLM training set.

### TECHNICAL FIELD

The disclosed configuration relates generally to batch selection of training examples, in particular applying batch selection of training examples for training large-scale machine-learned models.

### BACKGROUND

An existing goal of model training often includes increasing the speed and reducing the resources of training without significantly compromising the quality of training. One method for achieving this goal is called “batch selection,” a process that selects, from a subset of training data, a batch with which to train a model. Generally, a training process for a machine-learned model involves performing one or more iterations where each iteration processes a respective batch of the training data. One entire run through the training dataset is an epoch. In particular, the process includes applying the model to a batch of training examples for a current iteration, computing a loss for each of the training examples, and backpropagating to update the parameters of the model to reduce the loss. This process is repeated for subsequent iterations of the epoch until the entire training data set is processed. For subsequent epochs, the ordering of the training examples is shuffled, and this process is repeated for each epoch until a convergence criterion is reached.

For batch selection, the training system selects at each iteration, a subset of training examples from the training batch for the iteration which will affect the updates to parameters of the machine-learned model. For example, the subset of training examples are examples where the loss function was above a threshold for those training examples. The parameters of the machine-learned model may then be trained using the selected batch. In reducing the amount of training samples that pass through the model with every iteration, the batch sampling process may increase the speed of training and reduces the computing resources required for training. By selecting training examples where the loss function is high, the batch sampling process ensures that the model is exposed to “harder” training examples during training that result in more value, resulting in a more robust model than a model trained using a random sampling.

However, many large-scale machine-learned models have a significant number of parameters and the batch selection process does not scale well to such large-scale models, such as LLMs. Batch selection includes performing at least one forward pass of the set of training data through the model, even though the compute used on forward pass on the non-selected data is not used in updating the parameters. As larger models have more parameters and require a greater amount of training data, performing batch selection on a larger model poses a significant demand on the cost and computing resources.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 illustrates a block diagram of an architecture of a cluster computing system of the data layer, in accordance with an embodiment.

FIG. 5 is a block diagram of an architecture of a driver node, in accordance with an embodiment.

FIG. 6 is a flowchart of a method for batch selection for machine-learned language models, in accordance with an embodiment.

FIG. 7 is a block diagram illustrating an example machine to read and execute computer readable instructions, in accordance with an embodiment.

### DETAILED DESCRIPTION

A system performs a batch selection process on a small model and uses the results of batch selection to train a large language model (LLM). The system receives training examples and splits the training examples into a holdout set and an evaluation set. Each training example corresponds to a label. The system uses trains a small model using the training examples of the holdout set. The system evaluates the small model on the training examples of the evaluation set, generating a prediction for each training example and computing a loss between the prediction and the training example's label. The system generates an LLM training set by selecting a set of training examples from the evaluation set with the highest loss. The system trains the LLM using the LLM training set.

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

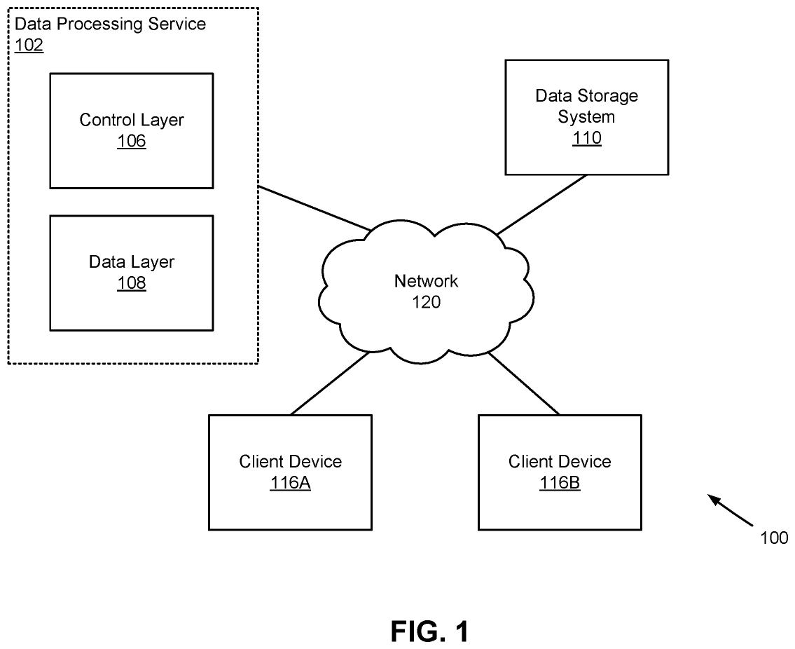

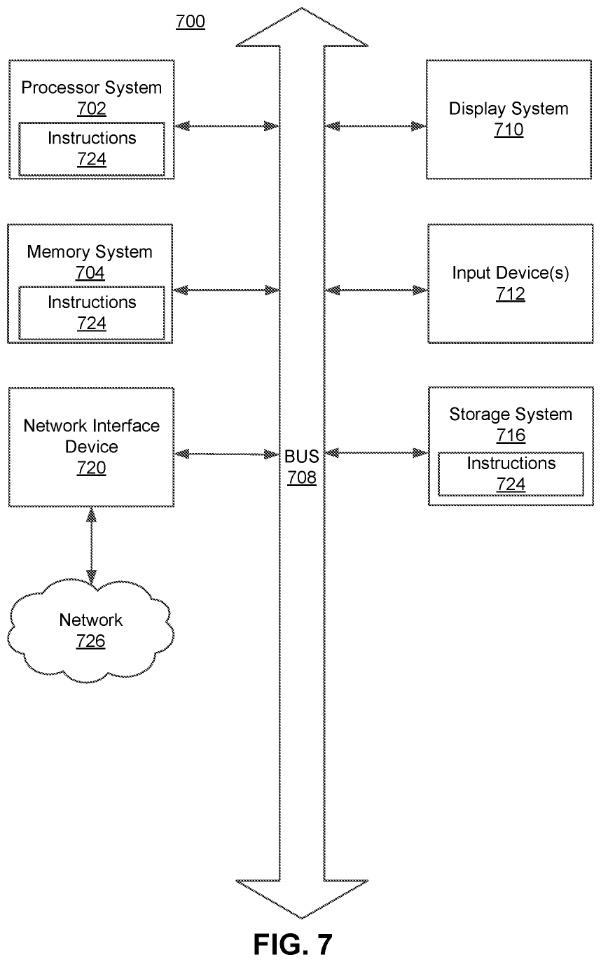

FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100. The computing systems of the system environment 100 may include some or all of the components (systems (or subsystems)) of a computer system 700 as described with FIG. 7.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

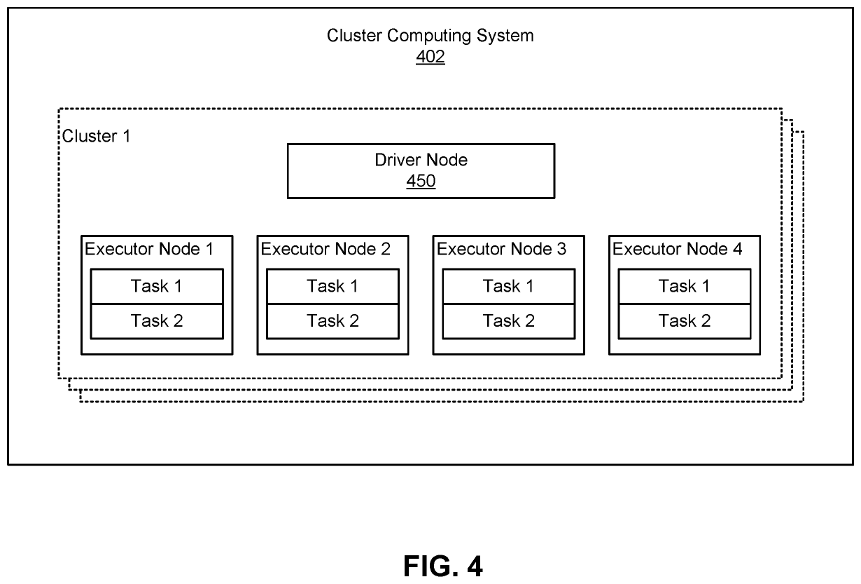

The data layer 108 includes multiple instances of clusters of computing resources that execute one or more jobs received from the control layer 106. Accordingly, the data layer 108 may include a cluster computing system for executing the jobs. An example of a cluster computing system is described in relation to FIG. 4. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, the data processing service 102 receives requests to deploy and train machine-learned models from users. For example, the data processing service 102 may deploy a trained machine-learned model on one or more containers hosted in the data layer 108. As another example, the data processing service 102 may train parameters of the machine-learned model using the powerful computing resources of the data layer 108 in conjunction with a dataset. Many machine-learned models are large-scale models, including more than 1 billion, 10's of billions, 100's of billions, even trillions of parameters, therefore, a high-level of computing resources may be used to deploy or train the large-scale models.

Generally, the training process for a machine-learned model includes performing one or more iterations where each iteration processes a batch of the training data. Specifically, for an epoch, the training data (e.g., millions or greater number of examples) is divided into a plurality of batches, and at each iteration, estimated parameters of the model for a current iteration are applied to the respective batch of training examples for the current iteration to generate predicted outputs. A loss is computed for each of the training examples based on the predicted outputs. An error term (e.g., gradients of loss) obtained from the loss function is backpropagated to update parameters of the large-scale model for the iteration to reduce the loss. This process is repeated for subsequent iterations of the epoch until the entire training data set is processed. For one or more subsequent epochs, the ordering of the training examples is shuffled, and this process is repeated for each epoch until a convergence criterion is reached.

An existing goal of model training often includes increasing the speed and reducing the resources of training without significantly compromising the quality of training. One way is to reduce the number of training examples that the model “sees” or processes to train the parameters of the model. Specifically, existing training data may not be subject to good quality control, and many training examples may not contribute significantly to training of the model (e.g., redundant or bad data). Therefore, computing resources may be wasted on these training examples. By selecting subsets of training examples that are more meaningful, the data processing service 102 may reduce the amount of training examples that pass through the model and decrease the required number of resources to achieve a certain level of performance of the machine-learned model.

One method for achieving this goal is called “batch selection,” which is a process that selects, at each iteration, a subset of training examples from the training batch for the iteration for which the loss for the selected examples will be backpropagated to update the parameters. For example, the subset of training examples are examples where the loss function was within a predetermined range (e.g., from the 75^{th} to 25^{th} percentiles). The parameters of the machine-learned model are updated for that iteration using the selected batch. However, for large-scale machine-learned models, batch selection includes performing at least one forward pass through the entire training data to evaluate which examples to select, even though the compute used on forward pass on the non-selected data is not used in updating the parameters. As larger models have more parameters and require a greater amount of training data, performing batch selection on a larger model poses a significant demand on resources.

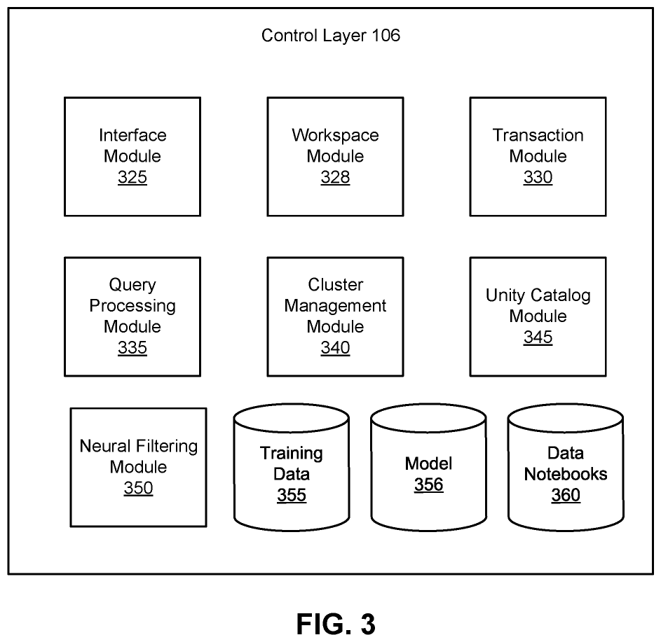

Thus, in one embodiment, the data processing service 102 herein uses a surrogate machine-learned model to evaluate the training examples and selects subsets of training examples that will be used to train parameters of the large-scale machine-learned model based on the evaluation performed by the surrogate model. The details of this method and system are described in detail in conjunction with the neural filtering module 350 of FIG. 3. Moreover, the remainder of the specification describes a text-based generation model (e.g., GPT, BERT, etc.) as the architecture for the surrogate model and the large-scale machine-learned model. However, it is appreciated that the method and system can be applied to training of machine-learned models of any appropriate architecture, such as diffusion models, latent diffusion models, or any other transformer-based architecture.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data storage system 110 may be managed by the same entity that manages the data processing service 102.

The client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client devices 116 of the system environment 100 may include some or all of the components (systems (or subsystems)) of a computer system 700 as described with FIG. 7.

In one embodiment, a client device 116 executes an application allowing a user of the client device 116 to interact with the various systems of the system environment 100 of FIG. 1. For example, a client device 116 can execute a browser application to enable interaction between the client device 116 and the control layer 106 via the network 120. In another embodiment, the client device 116 interacts with the various systems of the system environment 100 through an application programming interface (API) running on a native operating system of the client device 116, such as IOS® or ANDROID™.

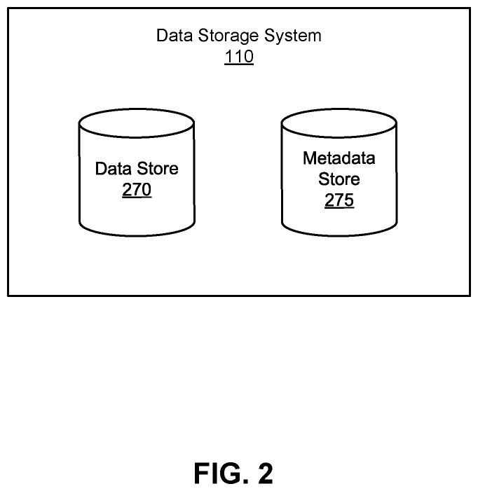

FIG. 2 is a block diagram of an architecture of a data layer 108, in accordance with an embodiment. In one embodiment, the data layer 108 includes a data ingestion module 250. The data layer 108 also includes a data store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data layer 108. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

FIG. 3 is a block diagram of an architecture of a control layer 106, in accordance with an embodiment. In one embodiment, the control layer 106 includes an interface module 325, a transaction module 330, a query processing module 335, a cluster management module 340, a unity catalog module 345, and a neural filtering module 350. The control layer 106 also includes a training data store 355 and a data notebook store 360. The modules 325, 330, 335, 340, and 350 may be structured for execution by a computer system, e.g., 700 having some or all of the components as described in FIG. 7, such that the computer system 700 operates in a specified manner as per the described functionality.

The interface module 325 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 325. The interface provided by the interface module 325 may include notebooks, libraries, experiments, queries submitted by the user. In one embodiment, a user may access the workspace via a user interface (UI), a command line interface (CLI), or through an application programming interface (API) provided by the interface module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

In some embodiments, the interface module 325 provides an interface for users to make requests to train models (e.g., LLMs). The interface module 325 may receive, from a user, the model and a set of training examples. The interface module 325 may also receive constraints on resources to use for training, for example a budget for training. The control layer 106 may train the model and provide the trained model to the user, for example by deploying the trained model in the data layer 108.

The workspace module 328 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The query processing module 335 receives and processes queries that access data stored by the data storage system 110. The query processing module 335 may reside in the control layer 106. The queries processed by the query processing module 335 are referred to herein as database queries. The database queries are specified using a declarative database query language such as the SQL. The query processing module 335 compiles a database query specified using the declarative database query language to generate executable code that is executed. The query processing module 335 may encounter runtime errors during execution of a database query and returns information describing the runtime error including an origin of the runtime error representing a position of the runtime error in the database query. In one embodiment, the query processing module 335 provides one or more queries to appropriate clusters of the data layer 108, and receives responses to the queries from clusters in which the queries are executed.

The unity catalog module 345 is a fine-grained governance solution for managing assets within the data processing service 102. It helps simplify security and governance by providing a central place to administer and audit data access. In one embodiment, the unity catalog module 345 maintains a metastore for a respective account. A metastore is a top-level container of objects for the account. The metastore may store data objects and the permissions that govern access to the objects. A metastore for an account can be assigned to one or more workspaces associated with the account. In one embodiment, the unity catalog module 345 organizes data as a three-level namespace, a catalog is the first layer, a schema (also called a database) is the second layer, and tables and views are the third layer.

In one embodiment, the unity catalog module 345 enables read and write of data to data stored in cloud storage of the data storage system 110 on behalf of users associated with an account and/or workspace. In one instance, the unity catalog module 345 manages storage credentials and external locations. A storage credential represents an authentication and authorization mechanism for accessing data stored on the data storage system 110. Each storage credential may be subject to access-control policies that control which users and groups can access the credential. An external location is an object that combines a cloud storage path (e.g., storage path in the data storage system 110) with a storage credential that authorizes access to the cloud storage path. Each storage location is subject to access-control policies that control which users and groups can access the storage credential. Therefore, if a user does not have access to a storage credential in the unity catalog module 345, the unity catalog module 345 does not attempt to authenticate to the data storage system 110.

In one embodiment, the unity catalog module 345 allows users to share assets of a workspace and/or account with users of other accounts and/or workspaces. For example, users of Company A can configure certain tables owned by Company A that are stored in the data storage system 110 to be shared with users of Company B. Each organization may be associated with separate accounts on the data processing service 102. Specifically, a provider entity can share access to one or more tables of the provider with one or more recipient entities.

Responsive to receiving a request from a provider to share one or more tables (or other data objects), the unity catalog module 345 creates a share in the metastore of the provider. A share is a securable object registered in the metastore for a provider. A share contains tables and notebook files from the provider metastore that the provider would like to share with a recipient. A recipient object is an object that associates an organization with a credential or secure sharing identifier allowing that organization to access one or more shares of the provider. In one embodiment, a provider can define multiple recipients for a given metastore. The unity catalog module 345 in turn may create a provider object in the metastore of the recipient that stores information on the provider and the tables that the provider has shared with the recipient. In this manner, a user associated with a provider entity can securely share tables of the provider entity that are stored in a dedicated cloud storage location in the data storage system 110 with users of a recipient entity by configuring shared access in the metastore.

The neural filtering module 350 performs a selection process using a surrogate model and uses the results of batch selection to train a large-scale machine-learned model such as a large language model (LLM). In one embodiment, the method and system for the selection process described below is performed in conjunction with the cluster computing system 402 (e.g., a cluster computing system 402 deployed within a data layer 108 of a customer of the data processing service 102).

In one embodiment, the selection process involves applying a surrogate model to a set of training examples, computing a loss for each of the training examples, and selecting a set of training examples for training the large-scale machine-learned model. In one instance, the selected set are examples where the surrogate model performed poorly or the loss was within a predetermined range, above a predetermined threshold, or otherwise satisfied some metric that deemed the training examples as being more valuable and contributory to training the parameters of the large-scale machine-learned model.

The small model, which may be referred to herein as a “surrogate model,” differs from the LLM in its number of parameters. In some embodiments, the number of parameters of the surrogate model differs from the number of parameters of the large-scale machine-learned model (e.g., LLM) by an order of magnitude. For example, the neural filtering module 350 may perform batch selection with a surrogate machine-learned model that has 120 million parameters to train an LLM with three billion parameters. While an LLM is referred to throughout the disclosure, the neural filtering module 350 may use the results of batch selection to train any type of model and is not limited to training an LLM.

The neural filtering module 350 receives a training dataset including a plurality of training examples. The neural filtering module 350 may split the training examples into one or more groups. For example, the neural filtering module 350 may split the training examples into a holdout set and an evaluation set. In one instance, for a text-based machine-learned model, a training example may include a sequence of tokens, where a token represents a text unit (e.g., word, sub-word) in a numerical latent or embedding space. The neural filtering module 350 uses the holdout set to train the surrogate model and uses the evaluation set to evaluate the surrogate model. In some embodiments, the holdout set may have a similar distribution of training examples as the evaluation set. In some embodiments, the neural filtering module 350 may split the training examples such that the holdout set contains less training examples than the evaluation set.

The neural filtering module 350 trains the surrogate model using the holdout set. For a given epoch (i.e., one run through the holdout set), the neural filtering module 350 divides the holdout set into a plurality of batches. The neural filtering module 350 trains the surrogate model by repeatedly iterating between a forward pass step and a backpropagation step to reduce a loss function. In the forward pass step for a current iteration, the neural filtering module 350 passes the batch of training examples for the iteration through the surrogate model, applying the estimated parameters of the surrogate model for that iteration. The neural filtering module 350 receives a set of predictions corresponding to the training examples. The neural filtering module 350 compares the set of predictions to the labels (e.g., known sequence of tokens of text units) of the training examples and computes a loss function. The loss indicates the difference between the set of predictions and the labels for the training examples.

The neural filtering module 350 may compute the loss using any type of loss function, for example a cross-entropy loss function, which is given by:

$$Loss = {\sum }_{i = 1}^{n} {y}_{i} log ( {p}_{i} )$$

where yᵢ is the label for a particular training example index i and pᵢ is the prediction for that index, and n is the number of tokens in the training example. In the backpropagation step, the neural filtering module 350 updates the parameters of the surrogate model based on error terms from the loss function. The neural filtering module 350 may iterate the forward pass and backpropagation steps for multiple batches of training examples over a set number of epochs (e.g., three epochs) or until a convergence criterion is reached (e.g., change in loss between iteration is less than a threshold change). The neural filtering module 350 may store the trained surrogate model in the training model store 356.

The neural filtering module 350 evaluates the surrogate model on the evaluation set. In some embodiments, the neural filtering module 350 evaluates the surrogate model on the evaluation set after fully training the surrogate model on the holdout set. The neural filtering module 350 applies the surrogate model to the evaluation set. The neural filtering module 350 passes the training examples of the evaluation set through the surrogate model, performing a forward pass. The neural filtering module 350 receives a set of predictions corresponding to the training examples. The neural filtering module 350 determines a loss for each of the training examples, the loss indicating the difference between the predictions and the labels for the training examples. The neural filtering module 350 may compute the loss with any suitable loss function (e.g., cross entropy loss). Since the surrogate model is a model with a smaller number of parameters than the large-scale model, the surrogate model is able to evaluate the value or loss functions of the training examples with lower degree of computing resources than when the large-scale machine-learned model evaluates the training examples.

The neural filtering module 350 generates a training set for the large-scale machine-learned model. The training set is a set of training examples the neural filtering module 350 uses to train the large-scale machine-learned model (e.g., LLM). In one instance, the neural filtering module 350 generates the training set from the “hardest” training examples in the evaluation set. The hardest training examples are training examples for which the evaluation from the surrogate model indicated that the examples are most meaningful or valuable to train parameters of the large-scale machine-learned model. For example, the surrogate model may perform poorly on when compared to the model's performance on other training examples.

In some embodiments, the hardest training examples are the training examples with the highest loss. In these embodiments, the neural filtering module 350 selects, from the evaluation set, a proportion of training examples from the evaluation set with the highest loss. The neural filtering module 350 may select examples where the loss is within a predetermined range or exceeds a loss threshold. The neural filtering module 350 may select a predetermined percentage of the training examples or number of training samples, for example the hardest 50% of training examples or the hardest 500 thousand training samples. The neural filtering module 350 may store the selected training examples in the training data store 355. In some embodiments, rather than select the training examples with the highest loss directly, the neural filtering may weigh the training examples such that training examples with high losses are weighted higher and may randomly select training examples for the training set for the large-scale machine-learned model.

The neural filtering module 350 may train the large-scale machine-learned model using the selected training set. The neural filtering module 350 may train the large-scale machine-learned model by repeatedly iterating between a forward pass step and a backpropagation step to reduce a loss function, much like how it trained the surrogate model except using the training set instead of the holdout set. In one embodiment, the neural filtering module 350 may train the large-scale machine-learned model over one or more epochs depending on a total budget that indicates a total number of examples to be processed or total cost allocated to training.

The number of epochs that the neural filtering module 350 trains the large-scale model may be related to the number of training examples in the training set and a budget. For example, for a budget that allows for training of one million examples and a training set with 500 thousand samples, the neural filtering module 350 may train the large-scale model over two epochs. For a budget that allows for training of one million examples and a training set with 250 thousand samples, the neural filtering module 350 may train the large-scale model over four epochs. In some embodiments, the neural filtering module 350 may generate the training set to have a particular number of samples based on the budget and a desired number of epochs. In this manner, when evaluating the training examples to select a training set for the large-scale machine-learned model, the smaller surrogate model can be used, while the selected subset of training examples in the evaluation set are used to train parameters of the large-scale model. In this manner, a select subset of training examples are identified that will provide high value to the training process of the large-scale machine-learned model for high performance given a total budget of examples to iterate over.

In some embodiments, the neural filtering module 350 performs an online version of batch selection to select the hardest or most meaningful training examples at each iteration of training of the surrogate model rather than after training has been completed. The neural filtering module 350 divides the training dataset into a plurality of batches for a given epoch.

At each iteration, the neural filtering module 350 passes the training examples of the batch for the iteration through the surrogate model, generates predictions corresponding to the training examples of the batch, and computes a loss function for the examples in the batch. The neural filtering module 350 selects a subset of examples in the batch (e.g., examples with loss function within a predetermined range) and stores the selected training examples (or indices of the examples) for the iteration in, for example, a storage or cache. The neural filtering module 350 may store the order of the batches along with the selected training examples from each batch. The neural filtering module 350 updates the parameters of the surrogate model based on the loss function of the selected training examples.

The neural filtering module 350 may proceed with repeating this process for subsequent iterations of training using the next batches from the training set, storing the selected examples for the next iteration in the storage or cache, and updating the parameters of the surrogate model using the selected training examples once again. This process may repeat for multiple iterations until the neural filtering module 350 is done training the surrogate model. In this manner, the neural filtering module 350 saves a trajectory of selected batches of training examples throughout the iterations for a given epoch that were used to train the surrogate model.

For example, say the neural filtering module 350 trains the surrogate model in two iterations. Say that the batch from the training set for the first iteration includes four training examples numbered one through four. In the first iteration of training, the neural filtering module 350 determines that example one has a loss of 0.25, example two has a loss of 0.65, example three has a loss of 0.40, and example four has a loss of 0.90. The neural filtering module 350 selects examples two and four as the hardest examples from the batch for the first iteration. The selected examples for the first iteration are stored in storage or a cache.

In the second iteration of training, the batch includes four training examples numbered five through eight. The neural filtering module 350 determines that example five has a loss of 0.30, example six has a loss of 0.15, example seven has a loss of 0.35, and example eight has a loss of 0.70. The neural filtering module 350 selects examples seven and eight as the hardest. The selected examples for the second iteration are stored in the storage of the cache.

Thus, the neural filtering module 350 generates the training set for the large-scale machine-learned model to include examples two and four for the first iteration (t=1), and examples seven and eight for the second iteration (t=2), and so on until the entire training dataset is processed for the epoch. In some embodiments, the neural filtering module 350 may adjust the number of training examples selected in each iteration, or select different number of training examples in different iterations.

Subsequently, the neural filtering module 350 may train the large-scale machine-learned model using the sequence of batches stored in the storage. For example, for each iteration, the parameters of the large-scale machine-learned model may be updated based on the selected batch in storage for that iteration selected based on the training process of the surrogate model. In this manner, the neural filtering module 350 may dynamically identify, for example, batches that are useful and more important at various points of the training process.

FIG. 4 is a block diagram of an architecture of a cluster computing system 402 of the data layer 108, in accordance with an embodiment. In some embodiments, the cluster computing system 402 of the data layer 108 includes driver node 450 and worker pool including multiple executor nodes. The nodes may be structured for execution by a computer system, e.g., 700 having some or all of the components as described in FIG. 7, such that the computer system 700 operates in a specified manner as per the described functionality.

The driver node 450 receives one or more jobs for execution, divides a job into job stages, and provides job stages to executor nodes, receives job stage results from the executor nodes of the worker pool, and assembles job stage results into complete job results, and the like. In one embodiment, the driver node receives a request to execute one or more queries from the query processing module 335. The driver node 450 may compile a database query and generate an execution plan. The driver node 450 distributes the query information including the generated code to the executor nodes. The executor nodes execute the query based on the received information.

The worker pool can include any appropriate number of executor nodes (e.g., 4 executor nodes, 12 executor nodes, 256 executor nodes). Each executor node in the worker pool includes one or more execution engines (not shown) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 450. According to an embodiment, an executor node executes the generated code for the database query for a particular subset of data that is processed by the database query. The executor nodes execute the query based on the received information from the driver node 450.

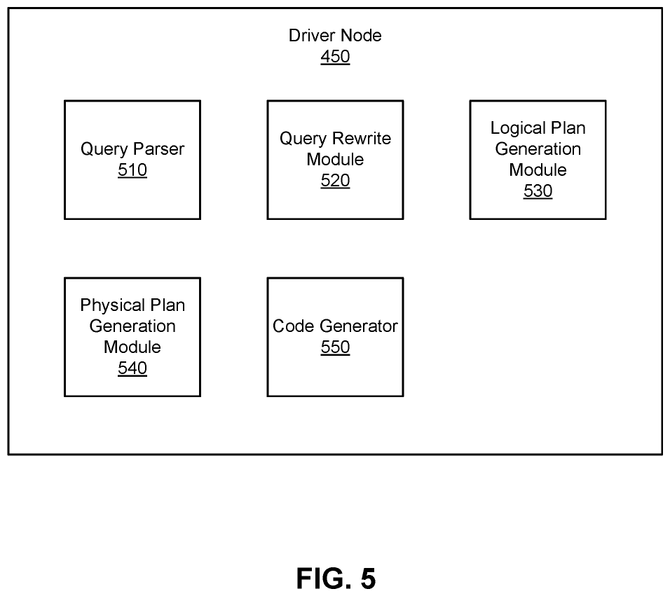

FIG. 5 is a block diagram of an architecture of a driver node 450, in accordance with an embodiment. In one instance, the driver node 450 includes a query parser 510, a query rewrite module 520, a logical plan generation module 530, and a physical plan generation module 540. The modules and nodes may be structured for execution by a computer system, e.g., 700 having some or all of the components as described in FIG. 7, such that the computer system 700 operates in a specified manner as per the described functionality.

The query parser 510 receives a database query for processing and parses the database query. The database query is specified using a declarative database query language such as SQL. The query parser 510 parses the database query to identify various tokens of the database query and build a data structure representation of the database query. The data structure representation identifies various components of the database query, for example, any SELECT expressions that are returned by the database query, tables that are input to the query, a conditional clause of the database query, a group by clause, and so on. According to an embodiment, the data structure representation of the database query is a graph model based on the database query.

The query rewrite module 520 performs transformations of the database query, for example, to improve the execution of the query. The improvement may be in terms of execution time, memory utilization, or other resource utilization. A database query may process one or more tables that store a significant number of records that are processed by the database query. Since the declarative database query language does not specify the procedure for determining the result of the database query, there are various possible procedures for executing the database query.

The query rewrite module 520 may transform the query to change the order of processing of certain steps, for example, by changing the order in which tables are joined, by changing the order in which certain operations such as filtering of records of a table is performed in relation to other operations. The query rewrite module 520 may transform the database query to cause certain temporary results to be materialized. The query rewrite module 520 may eliminate certain operations if the operations are determined to be redundant. The query rewrite module 520 may transform a database query so that certain computations such as subqueries or expressions are shared. The query rewrite module 520 may transform the database query to pushdown certain computations, for example, by changing the order in which certain predicates are applied to the computation as early as possible. The query rewrite module 520 may transform the database query to modify certain predicates to use more optimized versions of the predicates that are computationally equivalent but provide better performance.

The logical plan generation module 530 generates a logical plan for the database query. The logical plan includes representation of the various steps that need to be executed for processing the database query. According to an embodiment, the logical plan generation module 530 generates an unresolved logical plan based on the transformed query graph representation. Various relation names (or table names) and column names may not be resolved in an unresolved logical plan. The logical plan generation module 530 generates a resolved logical plan from the unresolved logical plan by resolving the relation names and column names in the unresolved logical plan. The logical plan generation module 530 further optimizes the resolved logical plan to obtain an optimized logical plan.

The physical plan generation module 540 generates a physical plan from the logical plan generated by the logical plan generation module 530. The physical plan specifies details of how the logical plan is executed by the data processing service 102. The physical plan generation module 540 may generate different physical plans for the same logical plan and evaluate each physical plan using a cost model to select the optimal physical plan for execution. The physical plan further specifies details of various operations of the logical plan. As an example, if the logical plan includes a join operator, the physical plan may specify the type of join that should be performed for implementing the join operator. For example, the physical plan may specify whether the join operator should be implemented as a hash join, merge join, or sort join, and so on. The physical plan may be specific to a database system, whereas the logical plan may be independent of database systems and may be executed on any target database system by converting to a physical plan for that target database system.

The code generator 550 generates code representing executable instructions for implementing the physical plan for executing a database query. The generated code includes a set of instructions for each operator specified in the execution plan. The generated code is specified using a programming language that may be compiled and executed.

### Batch Selection for Llms

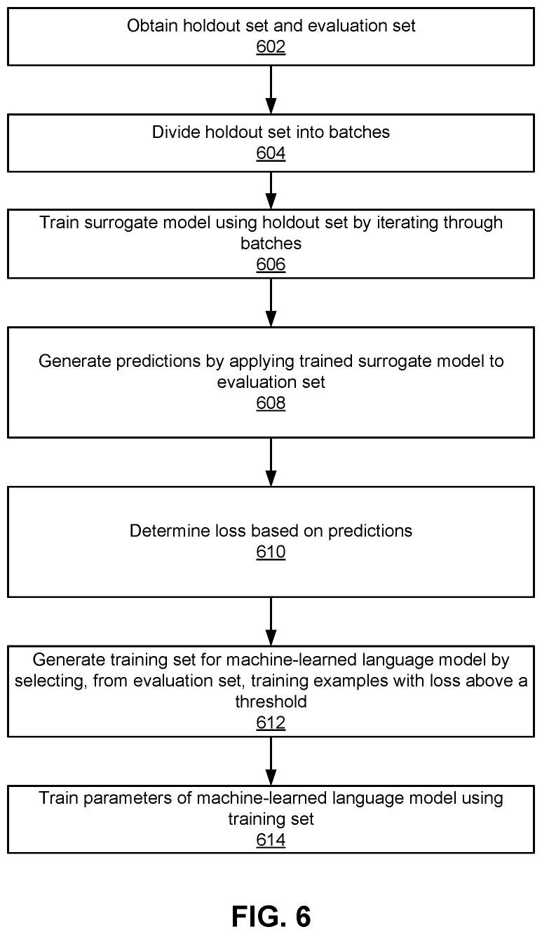

FIG. 6 is a flowchart of a method for batch selection for machine-learned language models, in accordance with an embodiment. The process shown in FIG. 6 may be performed by one or more components (e.g., the control layer 106) of a data processing system/service (e.g., the data processing service 102). Other entities may perform some or all of the steps in FIG. 6. The data processing service 102 as well as the other entities may include some or of the component of the machine (e.g., computer system) described in conjunction with FIG. 7. Embodiments may include different and/or additional steps, or perform the steps in different orders.

The process begins with the control layer 106 obtaining 602 training examples. The control layer may split the training examples into a holdout set and an evaluation set. The control layer may split the training examples such that the holdout set has the same distribution as the evaluation set. The control layer 106 divides 604 the holdout set into batches, each batch including a subset of training examples.

The control layer 106 trains 606 a surrogate model using the first set of training examples. The control layer 106 trains the surrogate model by repeatedly iterating between a forward pass step and a backpropagation step to reduce a loss function. The control layer 106 passes the training examples of the holdout set through the surrogate model, applying the parameters of the surrogate model. The control layer 106 receives a set of predictions corresponding to the training examples. The control layer 106 computes a loss function and updates the parameters of the surrogate model to reduce the loss function. The control layer 106 iterates the forward pass and backpropagation steps over a set number of epochs or until a convergence criterion is reached.

The control layer 106 evaluates the trained surrogate model on the evaluation set. For each training example in the evaluation set, the control layer 608 generates a prediction by applying the trained surrogate model to the training example. In applying the trained surrogate model, the control layer 106 passes the training examples of the evaluation set through the trained surrogate model, performing a forward pass. The control layer receives a set of predictions corresponding to the training examples. For each training example, the control layer 106 determines 610 a loss based on the prediction for the training example.

The control layer 106 generates 612 a training set from the hardest training examples in the evaluation set. The control layer 106 may generate the training set by selecting the training examples in the evaluation set that have the highest loss. The control layer 106 may select training examples where the loss is within a predetermined range. The control layer 106 may select a predetermined percentage of the training examples or number of training samples.

The control layer 106 trains 614 the machine-learned language model using the training set. The control layer 106 trains the machine-learned language model by repeatedly iterating between a forward pass step and a backpropagation step to reduce a loss function. The control layer 106 passes the training examples of the training set through the machine-learned language model, applying the parameters of the machine-learned language model. The control layer 106 receives a set of predictions corresponding to the training examples. The control layer 106 computes a loss function and updates the parameters of the machine-learned language model to reduce the loss function. The control layer 106 iterates the forward pass and backpropagation steps over a set number of epochs or until a convergence criterion is reached.

Turning now to FIG. 7, illustrated is an example machine to read and execute computer readable instructions, in accordance with an embodiment. Specifically, FIG. 7 shows a diagrammatic representation of the data processing service 102 (and/or data processing system) in the example form of a computer system 700. The computer system 700 is structured and configured to operate through one or more other systems (or subsystems) as described herein. The computer system 700 can be used to execute instructions 724 (e.g., program code or software) for causing the machine (or some or all of the components thereof) to perform any one or more of the methodologies (or processes) described herein. In executing the instructions, the computer system 700 operates in a specific manner as per the functionality described. The computer system 700 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 700 may be a server computer, a client computer, a personal computer (PC), a tablet PC, a smartphone, an internet of things (IoT) appliance, a network router, switch or bridge, or other machine capable of executing instructions 724 (sequential or otherwise) that enable actions as set forth by the instructions 724. Further, while only a single machine is illustrated, the term “machine” shall also be taken to include any collection of machines that individually or jointly execute instructions 724 to perform any one or more of the methodologies discussed herein.

The example computer system 700 includes a processing system 702. The processor system 702 includes one or more processors. The processor system 702 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 702 executes an operating system for the computer system 700. The computer system 700 also includes a memory system 704. The memory system 704 may include or more memories (e.g., dynamic random access memory (RAM), static RAM, cache memory). The computer system 700 may include a storage system 716 that includes one or more machine readable storage devices (e.g., magnetic disk drive, optical disk drive, solid state memory disk drive).

The storage unit 716 stores instructions 724 (e.g., software) embodying any one or more of the methodologies or functions described herein. For example, the instructions 724 may include instructions for implementing the functionalities of the transaction module 330 and/or the query processing module 335. The instructions 724 may also reside, completely or at least partially, within the memory system 704 or within the processing system 702 (e.g., within a processor cache memory) during execution thereof by the computer system 700, the main memory 704 and the processor system 702 also constituting machine-readable media. The instructions 724 may be transmitted or received over a network 726, such as the network 726, via the network interface device 720.

The storage system 716 should be taken to include a single medium or multiple media (e.g., a centralized or distributed database, or associated caches and servers communicatively coupled through the network interface system 720) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 700 can include a display system 710. The display system 710 may driver firmware (or code) to enable rendering on one or more visual devices, e.g., drive a plasma display panel (PDP), a liquid crystal display (LCD), or a projector. The computer system 700 also may include one or more input/output systems 712. The input/output (IO) systems 712 may include input devices (e.g., a keyboard, mouse (or trackpad), a pen (or stylus), microphone) or output devices (e.g., a speaker). The computer system 700 also may include a network interface system 720. The network interface system 720 may include one or more network devices that are configured to communicate with an external network 726. The external network 726 may be a wired (e.g., ethernet) or wireless (e.g., WiFi, BLUETOOTH, near field communication (NFC).

The processor system 702, the memory system 704, the storage system 716, the display system 710, the IO systems 712, and the network interface system 720 are communicatively coupled via a computing bus 708.

### Additional Considerations

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A method for training a first machine-learned language model, comprising:
obtaining a holdout set and an evaluation set, the holdout set including a first set of training examples and the evaluation set including a second set of training examples;
dividing the holdout set into a plurality of batches, each batch including a respective subset of training examples;
training a surrogate model using the holdout set by iterating through the plurality of batches, wherein the surrogate model is a second machine-learned language model;
evaluating the trained surrogate model on the evaluation set by:
generating a set of predictions by applying the trained surrogate model to the evaluation set, the set of predictions including a prediction for a training example in the evaluation set, and
determining, for the training example in the evaluation set, a loss based on the set of predictions for the training example;
generating a training set for the first machine-learned language model by selecting, from the evaluation set, a set of training examples with the loss within a predetermined range; and
training parameters of the first machine-learned language model for a first epoch using the selected training set.

2. The method of claim 1, wherein the second machine-learned language model has a smaller number of parameters than a number of parameters of the first machine-learned language model.

3. The method of claim 1, further comprising for at least a second epoch, training the parameters of the first machine-learned language model using the selected training set.

4. The method of claim 1, wherein training the surrogate model comprises repeatedly iterating between:
performing a forward pass step to generate a set of estimated predictions for a batch,
computing a loss function for the batch based on the set of estimated predictions, and
performing a backpropagation step to update parameters of the surrogate model to reduce the loss function.

5. The method of claim 1, wherein a training example is a sequence of tokens.

6. The method of claim 1, further comprising:
dividing the selected training set into another plurality of batches,
wherein training the first machine-learned language model comprises repeatedly iterating between:
performing a forward pass step to generate another set of estimated predictions for a batch in the another plurality of batches,
computing a loss function for the batch based on the another set of estimated predictions, and
performing a backpropagation step to update the parameters of the first machine-learned language model to reduce the loss function.

7. The method of claim 1, further comprising obtaining a total budget indicating a total number of training examples for training the parameters of the first machine-learned language model, and wherein a number of training examples in the selected training set is based on the total budget.

8. A non-transitory computer readable storage medium comprising stored program code, the program code comprising instructions, the instructions when executed causes a processor system to:
obtain a holdout set and an evaluation set, the holdout set including a first set of training examples and the evaluation set including a second set of training examples;
divide the holdout set into a plurality of batches, each batch including a respective subset of training examples;
train a surrogate model using the holdout set by iterating through the plurality of batches, wherein the surrogate model is a second machine-learned language model;
evaluate the trained surrogate model on the evaluation set by:
generate a set of predictions by applying the trained surrogate model to the evaluation set, the set of predictions including a prediction for a training example in the evaluation set, and
determine, for the training example in the evaluation set, a loss based on the set of predictions for the training example;
generate a training set for the first machine-learned language model by selecting, from the evaluation set, a set of training examples with the loss within a predetermined range; and
train parameters of the first machine-learned language model for a first epoch using the selected training set.

9. The non-transitory computer readable storage medium of claim 8, wherein the second machine-learned language model has a smaller number of parameters than a number of parameters of the first machine-learned language model.

10. The non-transitory computer readable storage medium of claim 8, wherein the instructions further comprise instructions to, for at least a second epoch, train the parameters of the first machine-learned language model using the selected training set.

11. The non-transitory computer readable storage medium of claim 8, wherein the instructions to train the surrogate model comprise instructions to repeatedly iterate between:
performing a forward pass step to generate a set of estimated predictions for a batch,
computing a loss function for the batch based on the set of estimated predictions, and
performing a backpropagation step to update parameters of the surrogate model to reduce the loss function.

12. The non-transitory computer readable storage medium of claim 8, wherein a training example is a sequence of tokens.

13. The non-transitory computer readable storage medium of claim 8, wherein the instructions further comprise instructions to:
divide the selected training set into another plurality of batches,
wherein the instructions to train the first machine-learned language model comprise instructions to repeatedly iterate between:
performing a forward pass step to generate another set of estimated predictions for a batch in the another plurality of batches,
computing a loss function for the batch based on the another set of estimated predictions, and
performing a backpropagation step to update the parameters of the first machine-learned language model to reduce the loss function.

14. The non-transitory computer readable storage medium of claim 8, wherein the instructions further comprise instructions to obtain a total budget indicating a total number of training examples for training the parameters of the first machine-learned language model, and wherein a number of training examples in the selected training set is based on the total budget.

15. A computer system, comprising:
a computer processor; and
a non-transitory computer readable storage medium comprising stored instructions that when executed by the computer processor, cause the computer system to:
obtain a holdout set and an evaluation set, the holdout set including a first set of training examples and the evaluation set including a second set of training examples;
divide the holdout set into a plurality of batches, each batch including a respective subset of training examples;
train a surrogate model using the holdout set by iterating through the plurality of batches, wherein the surrogate model is a second machine-learned language model;
evaluate the trained surrogate model on the evaluation set by:
generate a set of predictions by applying the trained surrogate model to the evaluation set, the set of predictions including a prediction for a training example in the evaluation set, and
determine, for the training example in the evaluation set, a loss based on the set of predictions for the training example;
generate a training set for the first machine-learned language model by selecting, from the evaluation set, a set of training examples with the loss within a predetermined range; and
train parameters of the first machine-learned language model for a first epoch using the selected training set.

16. The computer system of claim 15, wherein the second machine-learned language model has a smaller number of parameters than a number of parameters of the first machine-learned language model.

17. The computer system of claim 15, wherein the instructions further comprise instructions to, for at least a second epoch, train the parameters of the first machine-learned language model using the selected training set.

18. The computer system of claim 15, wherein the instructions to train the surrogate model comprise instructions to repeatedly iterate between:
performing a forward pass step to generate a set of estimated predictions for a batch,
computing a loss function for the batch based on the set of estimated predictions, and
performing a backpropagation step to update parameters of the surrogate model to reduce the loss function.

19. The computer system of claim 15, wherein a training example is a sequence of tokens.

20. The computer system of claim 15, wherein the instructions further comprise instructions to:
divide the selected training set into another plurality of batches,
wherein the instructions to train the first machine-learned language model comprise instructions to repeatedly iterate between:
performing a forward pass step to generate another set of estimated predictions for a batch in the another plurality of batches,
computing a loss function for the batch based on the another set of estimated predictions, and
performing a backpropagation step to update the parameters of the first machine-learned language model to reduce the loss function.
